(19) United States
(12) Patent Application Publication
(10) Pub. No.: US 2020/0240045 A1
(43) Pub. Date: Jul. 30, 2020

(54) BICOMPONENT FIBER ADDITIVE DELIVERY COMPOSITION

(71) Applicant: Earth Renewable Technologies, Brevard, NC (US)

(72) Inventors: Emanuel Lopes Martins, Curitiba (BR); Carmen E. Finnessy, Pisgah Forest, NC (US); Melvin Glenn Mitchell, Penrose, NC (US)

(21) Appl. No.: 16/845,840

(22) Filed: Apr. 10, 2020

Related U.S. Application Data
(63) Continuation of application No. 15/888,270, filed on Feb. 5, 2018.
(60) Provisional application No. 62/455,904, filed on Feb. 7, 2017.

(51) Int. Cl. D01F 8/06; C08L 71/12; C08L 55/02; C08L 27/18; C08L 27/06; C08L 25/06; C08J 3/20; D06M 10/04; C08K 9/12; C08L 33/08; C08L 67/04; C08J 5/18; D01F 8/04; D01F 1/02; D01D 5/30

(52) U.S. Cl. CPC D01F 8/06; D01F 8/14; C08L 55/02; C08L 27/18; C08L 27/06; C08L 25/06; C08J 3/20; D06M 10/04; C08K 9/12; C08L 33/08; C08L 67/04; C08J 5/18; D01F 8/04; D01F 1/02; D01D 5/30; C08L 71/12

(57) ABSTRACT

The biocomponent fiber functions as a carrier or vehicle for delivering additives to a polymer composition. The bicomponent fiber may be “splittable segmented pie” or “island-in-the-sea” construction with the sea being the low melt temperature component and the island being the high melt temperature component. The low melt temperature polymer may be selected from the group consisting of low density polyethylene (LDPE), high density polyethylene (HDPE), polylactic acid (PLA), polyhydroxyalkenoate (PHA), polypropylene (PP), polystyrene (PS), polyvinylidene fluoride, polybutylene succinate (PBS), low melt temperature polyethylene terephthalate, polytrimethylene terephthalate (PTT) and low melt temperature nylons. The high melt temperature component polymer is selected from the group consisting of polyethylene terephthalate (PET), co-polyester, polybutylene terephthalate (PBT), poly (methyl methacrylate) (PMMA), polytetrafluoroethylene (PTFE), polyether ether ketones (PEEK), polyphenylene sulfides (PPS), high melt temperature nylon, polylactic acid (PLA), including stereocomplex PLA, namely 100% PDLA, 100% PLLA or a 50/50 blend of 100% PDLA and 100% PLLA.

### CROSS-REFERENCE TO RELATED APPLICATION

This application is a continuation of U.S. application Ser. No. 15/888,270 filed Feb. 5, 2018, which claims priority to U.S. Provisional Application No. 62/455,904 filed Feb. 7, 2017, the disclosures of which are incorporated by reference in their entireties.

### FIELD OF THE INVENTION

The present invention relates to the use of bicomponent or bicomponent fibers as a vehicle or carrier for delivering additives to various polymeric compositions.

### BACKGROUND OF THE INVENTION

Polymeric compositions such as those used in molded articles of manufacture, fabrics, films, coatings, inks and paints, cosmetics and composites often require additives to improve properties like tensile strength, heat deflection temperature, brittleness, viscosity, impact strength, cure time, and the like. However, it is often difficult to incorporate such additives into the polymeric composition due to factors such as uptake, or an adverse effect on physical properties. One example is that many polymeric compositions are often difficult to color and typically the choices of color are limited. Thus, for example, extruded articles of manufacture, are only colored black or white or are transparent if the polymeric composition enables such. Additionally, if a wide variety of colors are desired, specialty colorants or pigments are often expensive. Colorants or pigments, also often impart undesired physical properties to the polymeric composition which must be overcome or avoided by adding other additives or altering the manufacturing process. For example, certain colorants added to an extrudable polymer composition tend to make the extruded article of manufacture brittle, have low toughness and less than optimum impact strength. These colorants also may be abrasive to process equipment and cause contamination to other products.

Thus, there is a need to provide a vehicle or mechanism to deliver various difficult to incorporate additives to a wide variety of polymeric materials.

### SUMMARY OF THE INVENTION

To this end, the present invention provides a bicomponent fiber having an additive added thereto or delivered therewith. The bicomponent fiber may be a microfiber. The biocomponent fiber functions as a carrier or vehicle for delivering additives to a polymer composition. The bicomponent fiber may be “splittable segmented pie” or “island-in-the-sea” construction with the sea being the low melt temperature component and the island being the high melt temperature component. The low melt temperature polymer may be selected from the group consisting of low density polyethylene (LDPE), high density polyethylene (HDPE), polylactic acid (PLA), polyhydroxyalkenoate (PHA), polypropylene (PP), polystyrene (PS), polyvinylidene fluoride, polybutylene succinate (PBS), low melt temperature polyethylene terephthalate, polytrimethylene terephthalate (PTT) and low melt temperature nylons. The second component comprises a high melt temperature polymer selected from the group consisting of polyethylene terephthalate (PET), co-polyester, polybutylene terephthalate (PBT), poly (methyl methacrylate) (PMMA), polytetrafluoroethylene (PTFE), polyether ether ketones (PEEK), polyphenylene sulfides (PPS), high melt temperature nylon, polylactic acid (PLA) (e.g., stereocomplex PLA), including 100% PDLA, 100% PLLA or a 50/50 blend of 100% PDLA and 100% PLLA).

In one embodiment, the additive may be added to the bicomponent fiber low melt temperature component or to the bicomponent fiber high melt temperature component.

In another embodiment, the additive may be compounded with the bicomponent fiber such as by using single or twin extrusion or using a continuous mixer.

The bicomponent fiber low melt temperature and high melt temperature components may be selected for compatibility with the additives and for providing additional properties to the polymer compositions to which the bicomponent fibers are added.

### BRIEF DESCRIPTION OF THE DRAWINGS

FIG. 1 is a schematic illustration of a method of forming the bicomponent fibers of one embodiment of the invention.

### DETAILED DESCRIPTION OF THE INVENTION

The foregoing and other aspects of the present invention will now be described in more detail with respect to the description and methodologies provided herein. It should be appreciated that the invention may be embodied in different forms and should not be construed as limited to the embodiments set forth herein. Rather, these embodiments are provided so that this disclosure will be thorough and complete, and will fully convey the scope of the invention to those skilled in the art.

The terminology used in the description of the invention herein is for the purpose of describing particular embodiments only and is not intended to be limiting of the invention. As used in the description of the embodiments of the invention and the appended claims, the singular forms “a,” “an” and “the” are intended to include the plural forms as well, unless the context clearly indicates otherwise. Also, as used herein, “and/or” refers to and encompasses any and all possible combinations of one or more of the associated listed items. Furthermore, the term “about,” as used herein when referring to a measurable value such as an amount of a compound, dose, time, temperature, and the like, is meant to encompass variations of 20%, 10%, 5%, 1%, 0.5%, or even 0.1% of the specified amount. When a range is employed (e.g., a range from x to y) it is it meant that the measurable value is a range from about x to about y, or any range therein, such as about x₁ to about y₁, etc. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Unless otherwise defined, all terms, including technical and scientific terms used in the description, have the same meaning as commonly understood by one of ordinary skill in the art to which this invention belongs.

It will be understood that although the terms “first,” “second,” “third,” “a),” “b),” and “c),” etc. may be used herein to describe various elements of the invention should not necessarily be limited by these terms. These terms are only used to distinguish one element of the invention from another. Thus, a first element discussed below could be termed an element aspect, and similarly, a third without departing from the teachings of the present invention. Thus, the terms “first,” “second,” “third,” “a),” “b),” and “c),” etc. are not intended to necessarily convey a sequence or other hierarchy to the associated elements but are used for identification purposes only. The sequence of operations (or steps) is not necessarily limited to the order presented in the claims and/or drawings unless specifically indicated otherwise.

All patents, patent applications and publications referred to herein are incorporated by reference in their entirety. In the event of conflicting terminology, the present specification is controlling.

The embodiments described in one aspect of the present invention are not limited to the aspect described. The embodiments may also be applied to a different aspect of the invention as long as the embodiments do not prevent these aspects of the invention from operating for its intended purpose.

The bicomponent fiber may be a multicomponent fiber having two or more components. Moreover, such fiber is typically a microfiber having a fineness of about less than about 10 d/f and often less than about 5 d/f. In operation, the fibers are extruded from separate extruders. The individual polymer type segments within the bicomponent fiber have a fineness of about less than about 10 microns and often less than about 5 microns. The polymers are arranged in substantially constantly positioned distinct zones across the cross-section of the fibers. The components may be arranged in any desired configuration and/or geometry, such as sheath-core, side-by-side, pie, splittable segmented pie, island-in-the-sea, and so forth. Various methods for forming bicomponent and multicomponent fibers are described in, for example, U.S. Pat. No. 4,789,592 to Taniguchi et al., U.S. Pat. No. 5,336,552 to Strack et al., U.S. Pat. No. 5,108,820 to Kaneko et al., U.S. Pat. No. 4,795,668 to Kruege et al., U.S. Pat. No. 5,382,400 to Pike et al, U.S. Pat. No. 6,200,669 to Marmon et al, and U.S. Pat. No. 8,710,172 to Wang et al. Bicomponent or multicomponent fibers having various irregular shapes may also be formed, such as described in U.S. Pat. No. 5,277,976 to Hogle et al., U.S. Pat. No. 5,162,074 to Hills, U.S. Pat. No. 5,466,410 to Hills, U.S. Pat. No. 5,069,970 to Largman et al, and U.S. Pat. No. 5,057,368 to Largman et al. An example of a bicomponent fiber is described in U.S. Publication No. 2016/0264776 the disclosure of which is incorporated by reference herein in its entirety.

In one aspect of the invention, the bicomponent fiber may comprise a low melt temperature “sea” component and a high melt temperature “island” component. Exemplary low melt temperature polymers include low density polyethylene (LDPE), high density polyethylene (HDPE), polylactic acid (PLA), polyhydroxyalkenoate (PHA), polypropylene (PP), polystyrene (PS), polyvinylidene fluoride, polybutylene succinate (PBS), low melt temperature polyethylene terephthalate, polytrimethylene terephthalate (PTT) and low melt temperature nylons. The low melt temperature sea component in one embodiment may be “bioHDPE”, i.e., a naturally-derived, non-petroleum based high density polyethylene (HDPE) available from Braskem (Brazil). In another embodiment, the low melt temperature sea component may be a naturally-derived PLA such as 7001D available from NatureWorks. The sea component may also be a petroleum based polymer such as low temperature nylon or low melt temperature polyethylene terephthalate (PET) or may be bioPET. The low temperature components typically have a melt temperature greater than about 50° C., sometimes greater than about 100°, and often greater than 150° C.

The high melt “island” component may be used to improve various mechanical properties of the polymeric composition to which it is added. Exemplary high melt temperature polymers include high melt temperature polyethylene terephthalate (PET), co-polyester, polybutylene terephthalate (PBT), poly (methyl methacrylate) (PMMA), polytetrafluoroethylene (PTFE), polyether ether ketones (PEEK), polyphenylene sulfides (PPS), high melt temperature nylon, polylactic acid (PLA), 100% PDLA, 100% PLLA or various blends of 100% PDLA and 100% PLLA. In one embodiment, the high melt temperature island component is a naturally-derived PET (bioPET) available from Toyota Tsusho. In another embodiment, the island component comprises 100% poly (L-lactic acid) (PLLA) or 100% poly (D-lactic acid) (PDLA). In another embodiment, the island component comprises a polylactic stereocomplex composition comprising about 20% to about 80% PLLA and about 80% to about 20% PDLA. In one embodiment, the stereocomplex-PLA composition is 50% PLLA and 50% PDLA, i.e., a 50/50 blend of PLLA and PDLA. Suitable stereocomplex PLLA and PDLA and blends thereof are available from Corbion (Netherlands) and Teijin (Japan). Such compositions are described, for example, in PCT Publication WO 2014/147132A1, U.S. Pat. No. 8,304,490B2 and U.S. Pat. No. 8,962,791B2. The high melt temperature components typically have a melt temperature greater than about 150° C., sometimes greater than about 200° C., and often greater than about 220° C. The selection of the melt temperatures of the low melt and high melt components will be within the skill of one in the art.

The cross-sectional shape or geometry of the bicomponent fiber may be pie-shaped, round, flat, trilobal and the like, the selection of which will be within the skill of one in the art.

Various additives may be included with the bicomponent fiber. Exemplary additive include but are not limited to pigments, dyes, fluorescents, colorants, inorganic fillers, including carbon black, clays, kaolin and the like, light blockers, compatibilizers, infrared absorbers, antimicrobials, gloss agents, anti-counterfeiting agents (e.g., fluorescent dyes, nanoparticles and quantum dots), impact modifiers, plasticizers, nucleating agents, dispersants, flame retardants, antistatic agents, peroxides, lubricants, and odor managers. Typically, the amount of additive present in or with the biocomponent fiber is 0.1 to 15 percent based on the overall weight of the polymer composition. The phrase “included with the bicomponent fiber” is intended to mean that the additive may be added to either the low melt temperature component or the high melt temperature component or may be compounded with the bicomponent fiber using a single or twin extrusion or continuous mixer such as when pelletizing the bicomponent fibers. Specifically, the bicomponent fibers may be a fiber concentrate in which the bicomponent fibers may be delivered as a fiber concentrate, namely a composition melted on a carrier resin. The fiber concentrate may be formed into a masterbatch.

As a means of illustration only, the second component in addition to the high melt temperature island may include an additive like a colorant. The colorant provides common colors for containers like white, amber, and green. In an embodiment wherein a white container is desired, titanium dioxide may be included. It is believed that by incorporating the colorant into the island high melt temperature component of the bicomponent fiber, that the color will be magnified in the base polymer. Thus, lower amounts of colorant may be used. For example, the addition of the colorant to the bicomponent fiber may result in color magnification of 10 to 50 times since the bicomponent fiber may be added at a level of 0.5 percent to 7 percent as contrasted to the conventional 3 to 7 percent add of colorant to a polymer base resin composition. Without being bound by a single theory, Applicants believe by utilizing the bicomponent fibers of the invention in microfiber form that the construction and geometries of the fibers may be utilized to alter light refraction/reflection and speed of light as it passes through the bicomponent fiber. Thus, this may contribute to the magnification of the color and may contribute to other color characteristics and attributes. If a low or high melt temperature polymer is used as the sea or island has chirality, light passing through the fiber may be altered differently depending on the chirality. Thus, PLLA will bend light to the left and PDLA will bend light to the right and a 50/50 stereocomplex blend will not bend light at all. Additionally, the speed of light in the low melt temperature polymer is faster than that in the high melt temperature polymer.

The bicomponent fibers may be added to a wide variety of base polymers and in amounts of 10% to 100% of the fibers melted in the resin. The base polymer may be petroleum-based. For example, in one embodiment, the base polymer may be only petroleum-based polymer having a melt temperature of at least 20° C. to 40° C. lower than the high melt temperature component of the bicomponent fiber. Suitable base polymers may include acetal, acrylic, acrylonitrile butadiene styrene, cellulose acetate, cellulose butyrate cellulose propionate, ethylene vinyl acetate, high and low density nylon, polybutylene terephthalate, polycyclohexylene dimethylene terephthalate, polyether ether ketone, polyethylene terephthalate, polycarbonate, polyetherimide, high and low density polyethylene, polypropylene, polystyrene, polyamide-imide, polyarylate, poly lactic acid, polytetrafluoroethane, polysulfonic poly (p-phenyleneoxide), polyvinyl chloride and mixtures, blends and copolymers thereof.

In another embodiment, the base polymer may be a polymer derived from a renewable resource such as polylactic acid (PLA), bioHDPE or bioPET. In another embodiment, the base polymer may be derived from a recycled polymer or polymers. For example, a PLA composition of the invention may be formulated so as to substantially mimic the properties of non-biodegradable conventional polymers derived from non-renewable resources (petroleum-based polymers). In one embodiment, the extrudable PLA composition has an HDT of greater than about 52° C., often greater than about 70° C. and sometimes greater than about 100° C., and a melt temperature between about 153° C. and about 230° C. The PLA may be copolymerized with other polymers or copolymers which may or may not be biodegradable and/or may or may not be naturally-derived or may or may not be derived from a recycled polymer. Exemplary polymers or copolymers may include polypropylene (PP), high density polyethylene (HDPE), aromatic/aliphatic polyesters, aliphatic polyesteramide polymers, polycaprolactones, polyesters, polyurethanes derived from aliphatic polyols, polyamides, polyethylene terephthalate (PET), polystyrene (PS), polyvinylchloride (PVC), and cellulose esters either in naturally-based and/or biodegradable form or not.

The base polymer composition may include natural oil, fatty acid, fatty acid ester, wax or waxy ester. In one embodiment, the natural oil, fatty acid, fatty acid ester, wax or waxy ester is coated on pellets of the polymer using agitation. A blend or mixture of the natural oil, fatty acid, wax or waxy ester may be used.

In an embodiment, the base polymer composition may include a natural oil. Suitable natural oils include lard, beef tallow, fish oil, coffee oil, soy bean oil, safflower oil, tung oil, tall oil, calendula, rapeseed oil, peanut oil, linseed oil, sesame oil, grape seed oil, olive oil, jojoba oil, dehydrated castor oil, tallow oil, sunflower oil, cottonseed oil, corn oil, canola oil, orange oil, and mixtures thereof.

Suitable waxes include naturally-derived waxes and waxy esters may include without limitation, bees wax, plant-based waxes, bird waxes, non-bee insect waxes, and microbial waxes. Waxy esters also may be used. As utilized herein, the term ‘waxy esters’ generally refers to esters of long-chain fatty alcohols with long-chain fatty acids. Chain lengths of the fatty alcohol and fatty acid components of a waxy ester may vary, though in general, a waxy ester may include greater than about 20 carbons total. Waxy esters may generally exhibit a higher melting point than that of fats and oils. For instance, waxy esters may generally exhibit a melting point greater than about 45° C. Additionally, waxy esters encompassed herein include any waxy ester including saturated or unsaturated, branched or straight chained, and so forth. Waxes have been found to provide barrier properties in extruded articles of manufacture, such as reduced Oxygen Transfer and Water Vapor Transfer.

Suitable fatty esters or fatty acid esters are the polymerized product of an unsaturated higher fatty acid reacted with an alcohol. Exemplary high fatty esters include oleic ester, linoleic ester, resinoleic ester, lauric ester, myristic ester, stearic ester, palmitic ester, eicosanoic ester, eleacostearic ester, and the like, and mixtures thereof.

These esters may be combined with suitable oils, as well as various esters derived from carboxylic acids may be included to act as plasticizers for the polymer. Exemplary carboxylic acids include acetic, citric, tartaric, lactic, formic, oxalic and benzoic acid. Furthermore, these acids may be reacted with ethanol to make an acid ethyl ester, such as ethyl acetate, ethyl lactate, monoethyl citrate, diethyl citrate, triethyl citrate (TEC). Most naturally occurring fats and oils are the fatty acid esters of glycerol.

Other additives in the base polymer may include natural or synthetic plasticizers such as impact modifiers, fiber reinforcement other than nanofibers, antioxidants, antimicrobials, fillers, UV stabilizers, glass transition temperature modifiers, melt temperature modifiers and heat deflection temperature modifiers.

It is noted that the above description is the embodiment in which the polymer composition is extrudable and a molded article of manufacture results. The bicomponent fibers may be added to fabrics, films, fiber spinning coatings, inks and paints, cosmetics and composites. In one embodiment, a masterbatch may be used. By utilizing a masterbatch, the often more expensive additives may be first compounded in larger percentage amounts into the masterbatch and then added to the polymer composition. Such use of a masterbatch may be used to incorporate additives more cost effectively, for example, those that improve properties like barrier properties, flexibility properties, HDT properties, and the like. Another example is that a masterbatch may be formulated so that the consumer has the capability of customizing. For example, some amount of the bicomponent fiber and the base colorant (the amount of additive incorporated into the polymer composition) may be added to a portion of the polymer composition, then this is combined to result in the end composition having the desired color.

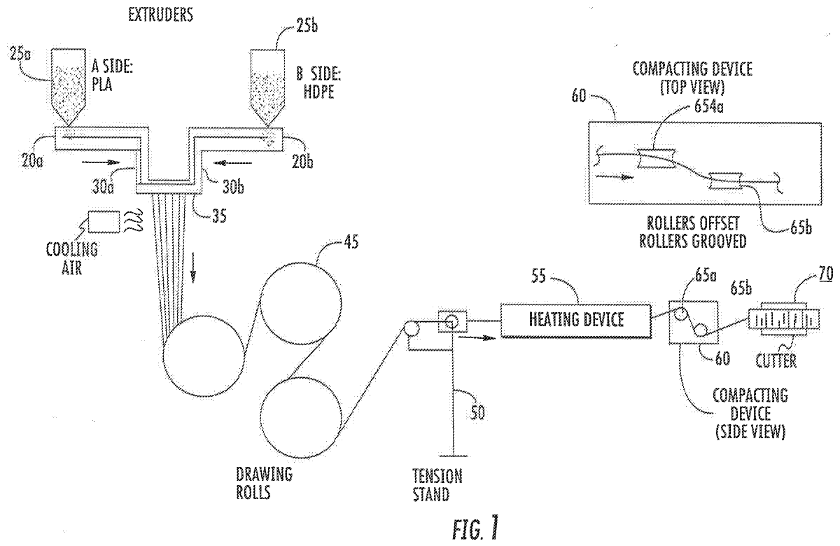

Referring to FIG. 1, one embodiment of a method of forming bicomponent fibers is illustrated. The illustrated embodiment shows a continuous line of forming the fibers noting that the method could involve spinning the fibers, placing on a spool and at a later time drawings and cutting the fibers on a separate line. In general, the components of the bicomponent fiber are extruded through a spinneret, quenched, and drawn into a vertical passage of a fiber drawn unit.

The high melt component and the low melt component are fed into extruders 20a and 20b from hoppers 25a and 25b. The extruder is heated to a temperature above that of the low melt component. The high and low melt components are fed through conduit 30a, 30b to a spinneret 35. Such spinnerets for extruding bicomponent fibers are well known to those skilled in the art. For example, various patterns of openings in the spinneret can be used to create various flow patterns of the high and low melt components. A quench blower 40 to provide cooling air may be positioned to one side of the filaments as shown or may be positioned on both sides.

The filaments are then passed from drawing rolls 45, placed under tension using a tension stand 50 and delivered to a heating device 55 to heat the fiber above the softening point of the low melt component so that sufficient melt occurs to act as a bonding agent that holds the high melt fibers together.

The fibers are then compacted using compaction device 60. In one embodiment, this is accomplished by creation of a small twist in the tow band of the fully oriented yarn using a series of rollers 65a, 65b, in one embodiment grooved rollers. Such a twist aids in applying pressure to create a semi-permanent bond of the low melt component after heating to its softening point. In one embodiment, the 65a, 65b are slightly offset from each other such that the path of the tow passing through the two grooved rolls creates two distinct turns within a distance of less than eight inches. The first turn of the tow should produce an angle of about 140-170 degrees as measured to the outside of the original path of the tow. The second turn should produce an angle of approximately equal angularity to the first but turning in the opposite direction as measured to the inside of the new path of the tow after the second turn. The sharper the angle, the tighter the twist and adjustment of the angle will result in higher efficiency of compaction.

After compaction, an optional lubrication stand, including a kiss roll (not shown) may be used to add 0.1% to 5.0% of a lubricant to the fiber prior to cutting. The bicomponent fiber may be cut using a cutter 70 to a length of not greater than 6 mm, sometimes not greater than 3 mm and often not greater than 1.5 mm. After cutting, the fiber may be dried to less than 100 ppm.

In another embodiment, the filaments of the individually spun yarns may be spun simultaneously into a larger type of monofilament of a uniform diameter and equal in denier to the combination of up to 144 individual yarns composed of 3 denier-per-filament by designing the spin pack such that the cross section of the monofilament may contain many multiples of the individual filaments. For example, instead of a spin die containing 288 filaments that when wound together create an 864 denier (DEN) yarn wound onto a bobbin. The individual monofilament would be 864 DEN. The result would be a single filament, i.e. a monofilament, with a cross section containing 4,608 pie shapes in a roughly concentric formation, but formed to alternate high melt and low melt components within each distinct sixteen pie segment shape within its whole. To accommodate this design, the monofilament may be spun in from a horizontally oriented spin die instead of a vertically oriented spin die. The orientation of the spin die to horizontal will allow the filament to be quenched immediately in either a trough type water bath or via an underwater chopper, such as Gala Underwater Pelletizer type chopper. In another embodiment, after heating the fiber in the heating device 55, the compaction step may be done at a later time as a separate non-continuous process. The following examples will serve to further exemplify the nature of the invention but should not be construed as a limitation on the scope thereof, which is defined by the appended claims.

### EXAMPLES

### Example 1 (White)

A splittable segmented pie bicomponent microfiber was spun at 2000m/min on a Hills Spin Line. The sea component comprised 40 percent bioHDPE and the island component comprised 53 percent bioPET and 7 percent Snow White colorant available from Universal Colors.

### Example 2 (Amber)

A splittable segmented pie bicomponent microfiber was spun at 2000m/min on a Hills Spin Line. The sea component comprised 40 percent 7001D PLA and the island component comprised 57 percent stereocomplex PLA and 3 percent transparent amber available from PolyOne.

### Example 3

A splittable segmented pie bicomponent microfiber was spun at 2000m/min on a Hills Spin Line. The sea component comprised 50 percent HDPE and the island component comprised 49 percent PLLA/PDLA 50/50 blend and 1 percent TiO₂ with the components bonded together. This was added at a 5 percent level to a base polymer comprising Corbion PLLA L130 and formed into film to measure gloss, brightness and opacity.

### Example 4

The bicomponent fibers of Example 3 were added at a 10 percent level to the Example 3 base polymer and formed into a film to measure gloss, brightness and opacity.

Examples 3 and 4 were compared to the base polymer with no bicomponent fiber addition comparative with Example A and with a 5 percent bicomponent fiber addition wherein the bicomponent fiber had no colorant added. The results are shown in Tables 1-3.

TABLE 1
Gloss

| Example | Gloss @60° (%) |
|---|---|
| Comparative Example A | 83.4 |
| Comparative Example B | 56.8 |
| Example 3 | 59.9 |
| Example 4 | 66.7 |

TABLE 2
Brightness

| Example | Brightness (%) |
|---|---|
| Comparative Example A | 81.2 |
| Comparative Example B | 82.2 |
| Example 3 | 83.7 |
| Example 4 | 85.1 |

TABLE 3
Opacity

| Example | Opacity (%) |
|---|---|
| Comparative Example A | 2.9 |
| Comparative Example B | 34.4 |
| Example 3 | 49.0 |
| Example 4 | 66.5 |

Having thus described certain embodiments of the present invention, it is to be understood that the invention defined by the appended claims is not to be limited by particular details set forth in the above description as many apparent variations thereof are possible without departing from the spirit or scope thereof as hereinafter claimed.

What is claimed:

1. An extrudable polymeric composition comprising:
a) a base polymer;
b) a bicomponent fiber comprising a first component comprising a low melt temperature polymer selected from the group consisting of low density polyethylene (LDPE), high density polyethylene (HDPE), polylactic acid (PLA), polypropylene, polystyrene, polyvinylidene fluoride, polybutylene succinate (PBS), low melt temperature polyethylene terephthalate and low melt temperature nylons and a second component comprising a high melt temperature polymer selected from the group consisting of high melt temperature polyethylene terephthalate (PET), co-polyesters, polybutylene terephthalate (PBT), poly (methyl methacrylate) (PMMA), polytetrafluoroethylene (PTFE), polyether ether ketones (PEEK), polyphenylene sulfide (PS), high melt temperature nylon, polylactic acid (PLA), 100% PDLA, 100% PLLA and a 50/50 blend of 100% PDLA and 100% PLLA, wherein the base polymer has a melt temperature of about 20° C. to 150° C. lower than the high melt temperature polymer of the bicomponent fiber; and
c) an additive included within the bicomponent fiber;
wherein at least a portion of the bicomponent fibers are melted in the base polymer.

2. The extrudable polymeric composition of claim 1, wherein the base polymer is selected from the group consisting of acetal, acrylic, acrylonitrile butadiene styrene, cellulose acetate, cellulose butyrate cellulose propionate, ethylene vinyl acetate, nylon, polybutylene terephthalate, polycyclohexylene dimethylene terephthalate, polyether ether ketone, polyethylene terephthalate, polycarbonate, polyetherimide, polyethylene, polypropylene, polystyrene, polyamide-imide, polyarylate, polytetrafluoroethane, polysulfonic poly (p-phenyleneoxide), polyvinyl chloride and mixtures, blends and copolymers thereof.

3. The extrudable polymeric composition of claim 1, wherein the bicomponent fiber is a microfiber having a splittable segmented pie construction.

4. The extrudable polymeric composition according to claim 1, wherein the additive is selected from the group consisting of pigments, dyes, fluorescents, colorants, inorganic fillers, including carbon black, clays, kaolin and the like, light blockers, compatibilizers, infrared absorbers, antimicrobials, gloss agents, anti-counterfeiting agents, impact modifiers, plasticizers, nucleating agents, dispersants, flame retardants, antistatic agents, peroxides, lubricants, and odor managers.

5. The extrudable polymeric composition according to claim 4, wherein the additive is present in the amount of 0.1 to 15 percent based on the overall weight of the polymer composition.

6. The extrudable polymeric composition according to claim 5, wherein the additive is incorporated into the high melt temperature polymer of the bicomponent fiber.

7. The extrudable polymeric composition according to claim 6, wherein the additive is present in the amount of 0.5 to 7 percent based on the overall weight of the polymer composition.

8. The extrudable polymeric composition according to claim 5, wherein the additive is incorporated into the low melt temperature polymer of the bicomponent fiber.

9. The extrudable polymeric composition according to claim 1 further including an additive within the base polymer.

10. The extrudable polymeric composition according to claim 9, wherein the additive within the base polymer is selected from the group consisting of natural or synthetic plasticizers, fiber reinforcement other than nanofibers, antioxidants, antimicrobials, fillers, UV stabilizers, glass transition temperature modifiers, melt temperature modifiers and heat deflection temperature modifiers.

11. The extrudable polymeric composition according to claim 1, wherein at least 10% of the bicomponent fibers are melted in the base polymer.
